(19) United States
(12) Patent Application Publication
(10) Pub. No.: US 2017/0139662 A1
(43) Pub. Date: May 18, 2017

(54) DISPLAY UNIT FOR CONCURRENTLY DISPLAYING MULTIPLE FRAME

(71) Applicant: LITEMAX ELECTRONICS INC., NEW TAIPEI CITY (TW)

(72) Inventor: CHING-CHANG CHEN, NEW TAIPEI CITY (TW)

(21) Appl. No.: 14/939,197

(22) Filed: Nov. 12, 2015

(51) Int. Cl. G06F 3/14; G06F 3/147

(52) U.S. Cl. CPC G06F 3/1446; G06F 3/1431; G06F 3/147

(57) ABSTRACT

A display unit for concurrently displaying multiple frames includes a liquid crystal panel; a control unit electrically connected to the liquid crystal panel; a transparent plate disposed in front of the liquid crystal panel; and a printed pattern layer printed on the transparent plate and having at least two hollow-cored portions whereby the transparent plate is defined with display regions corresponding in quantity to the hollow-cored portions, wherein the control unit drives the liquid crystal panel to produce local frames which are displayed in the display regions and are not outnumbered by the display regions. Hence, the display unit produces multiple partitioned frames with just one liquid crystal panel, just one control unit, and a printed pattern layer.

### FIELD OF TECHNOLOGY

The present invention relates to display units and more particularly to a display unit which requires just one liquid crystal panel and just one control unit to concurrently display multiple frames.

### BACKGROUND

Elevators, for example, are each equipped with multiple display units nowadays to display multiple electronic advertisements. As a result, the display units add to the structural complexity of the elevators in terms of equipment, assembly and load.

Furthermore, when multiple display units are mounted on the same plane, their respective frames are predisposed to time lag, but it takes much time to correct the frames and carry out synchronous display process.

Accordingly, it is imperative to provide a display unit with one liquid crystal panel and one control unit for concurrently displaying multiple frames to thereby overcome the aforesaid drawbacks of the prior art.

### SUMMARY

In view of the aforesaid drawbacks of the prior art, it is an objective of the present invention to provide a display unit for concurrently displaying multiple frames, wherein the display unit requires only one liquid crystal panel and one control unit to concurrently display multiple frames, thereby simplifying the equipment and assembly of the display unit.

In order to achieve the above and other objectives, the present invention provides a display unit for concurrently displaying multiple frames, comprising: a liquid crystal panel being integral and not partitioned; a control unit electrically connected to the liquid crystal panel; a transparent plate disposed in front of the liquid crystal panel; and a printed pattern layer printed on the transparent plate and having at least two hollow-cored portions whereby the transparent plate is defined with display regions corresponding in quantity to the hollow-cored portions, wherein the control unit drives the liquid crystal panel to produce local frames which are displayed in the display regions and are not outnumbered by the display regions.

Regarding the display unit for concurrently displaying multiple frames, the local frames are displayed in the display regions, respectively, when the display regions and the local frames are equal in number.

Regarding the display unit for concurrently displaying multiple frames, at least one of the display regions displays two local frames simultaneously when the display regions are outnumbered by the local frames.

In conclusion, the present invention provides a display unit for concurrently displaying multiple frames such that the display unit requires just one liquid crystal panel, just one control unit, and a printed pattern layer with at least two hollow-cored portions to produce multiple partitioned frames for use in displaying electronic advertisements at a venue, thereby simplifying the equipment and assembly of the display unit.

### BRIEF DESCRIPTION

Objectives, features, and advantages of the present invention are hereunder illustrated with specific embodiments in conjunction with the accompanying drawings, in which:

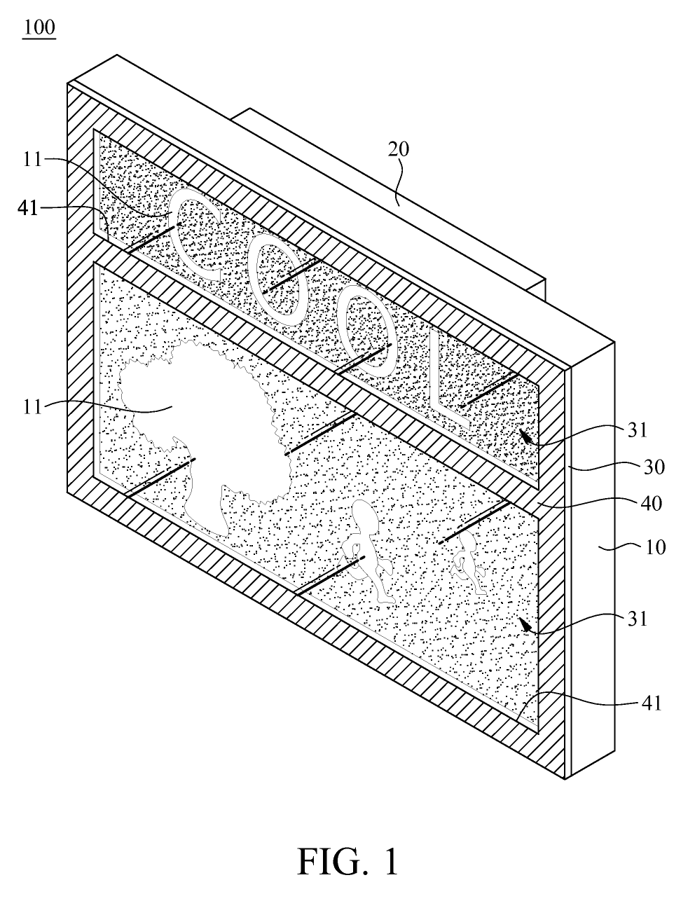

FIG. 1 is a schematic view of a display unit for concurrently displaying multiple frames according to the present invention; and

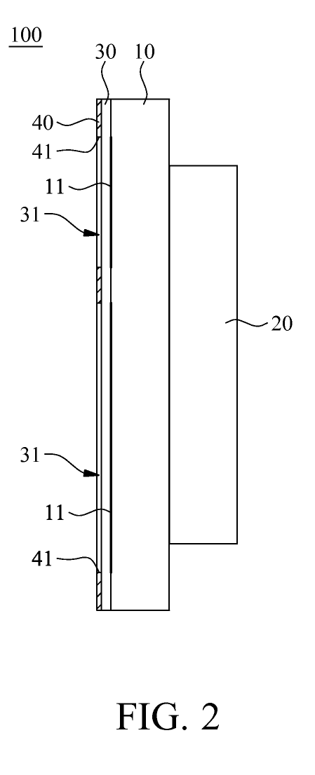

FIG. 2 is a cross-sectional view of the display unit for concurrently displaying multiple frames according to the present invention.

### DETAILED DESCRIPTION

Referring to FIG. 1 and FIG. 2, the present invention provides a display unit 100 for concurrently displaying multiple frames. The display unit 100 comprises a liquid crystal panel 10, a control unit 20, a transparent plate 30 and a printed pattern layer 40.

The liquid crystal panel 10 is integral and not partitioned. The dimensions of the liquid crystal panel 10 are subject to changes as needed. The control unit 20 is electrically connected to the liquid crystal panel 10, such that the liquid crystal panel 10 produces a plurality of local frames 11. The local frames 11 are displayed either synchronously or asynchronously. The transparent plate 30 is disposed in front of the liquid crystal panel 10. The transparent plate 30 is made of transparent glass or transparent plastic to hide the liquid crystal panel 10 but still allow the local frames 11 to be shown through the transparent plate 30. The printed pattern layer 40 is printed on the transparent plate 30. The printed pattern layer 40 has at least two hollow-cored portions 41. The hollow-cored portions 41 enable the transparent plate 30 to be defined with display regions 31. The display regions 31 correspond in quantity to the hollow-cored portions 41. For example, referring to FIG. 1, the hollow-cored portions 41 are in the number of two, and the display regions 41 are also in the number of two. The local frames 11 are displayed in the display regions 31. The display regions 31 do not outnumber the local frames 11.

The display unit 100 of the present invention is characterized in that: the local frames 11 are respectively displayed in the partitioned display regions 31 to thereby bring about various advertising effects; but the display unit 100 requires just one liquid crystal panel 10 and just one control unit 20 to function, thereby simplifying the display unit 100 and cutting the manufacturing costs thereof

The display unit 100 of the present invention is further characterized in that the contents of the local frames 11 correlate with each other. The local frames 11 shown at the top of FIG. 1 display a text of advertisement, whereas the local frames 11 shown at the bottom of FIG. 1 display patterns or animations pertaining to the text, interactive patterns (not shown) or animations (not shown) pertaining to the text. Furthermore, the local frames 11 can display patterns, animations or texts of two unrelated advertisements.

Referring to FIG. 1, the hollow-cored portions 41 are rectangular, but the present invention is not limited thereto. Alternatively, the hollow-cored portions 41 are round, elliptical, triangular, any other geometric shape, any shape corresponding to a desirable advertisement, or any other common shape.

Referring to FIG. 1 and FIG. 2, the display regions 31 and the local frames 11 are equal in number. The local frames 11 are displayed in the display regions 31, respectively. But the present invention is not limited thereto. If the display regions 31 is outnumbered by the local frames 11, for example, when the display regions 31 are in the number of two, and the local frames are in the number of three, at least one of the display regions 31 displays two local frames 11 simultaneously, thereby bringing about various display effects.

In conclusion, the present invention provides a display unit for concurrently displaying multiple frames such that the display unit requires just one liquid crystal panel, just one control unit, and a printed pattern layer with at least two hollow-cored portions to produce multiple partitioned frames for use in displaying electronic advertisements at a venue, thereby simplifying the equipment and assembly of the display unit.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A display unit for concurrently displaying multiple frames, comprising:
a liquid crystal panel being integral and not partitioned;
a control unit electrically connected to the liquid crystal panel;
a transparent plate disposed in front of the liquid crystal panel; and
a printed pattern layer printed on the transparent plate and having at least two hollow-cored portions whereby the transparent plate is defined with display regions corresponding in quantity to the hollow-cored portions,
wherein the control unit drives the liquid crystal panel to produce local frames which are displayed in the display regions and are not outnumbered by the display regions.

2. The display unit of claim 1, wherein the local frames are displayed in the display regions, respectively, when the display regions and the local frames are equal in number.

3. The display unit of claim 1, wherein at least one of the display regions displays two local frames simultaneously when the display regions are outnumbered by the local frames.
